(19) United States
(12) Patent Application Publication
(10) Pub. No.: US 2022/0132639 A1
(43) Pub. Date: Apr. 28, 2022

(54) CONTROL DEVICE, CONTROL METHOD, AND STREETLIGHT

(71) Applicant: Toyota Jidosha Kabushiki Kaisha, Toyota-shi Aichi-ken (JP)

(72) Inventor: Ai Miyata, Okazaki-shi (JP)

(73) Assignee: Toyota Jidosha Kabushiki Kaisha, Toyota-shi Aichi-ken (JP)

(21) Appl. No.: 17/402,944

(22) Filed: Aug. 16, 2021

(30) Foreign Application Priority Data
Oct. 23, 2020 (JP) 2020-178453

(51) Int. Cl. H05B 47/125; H04W 4/029; H04W 4/02; G06T 7/11

(52) U.S. Cl. CPC H05B 47/125; H04W 4/029; G06T 2207/30184; G06T 7/11; H04W 4/026

(57) ABSTRACT

A control device includes a control unit configured to acquire an image of a subject which is captured by a terminal device and to control at least one streetlight which is provided near the terminal device based on the acquired image.

### CROSS-REFERENCE TO RELATED APPLICATION

This application claims priority to Japanese Patent Application No. 2020-178453 filed on Oct. 23, 2020, incorporated herein by reference in its entirety.

### BACKGROUND

### 1. Technical Field

The present disclosure relates to a control device, a control method, and a streetlight.

### 2. Description of Related Art

In the related art, a technique of enabling capturing of an image in a dark place by causing an irradiation position of a lighting device to conform to a position of a subject is known. For example, Japanese Unexamined Patent Application Publication No. 2002-083383 (JP 2002-083383 A) discloses a technique of detecting a position of a subject using a noncontact sensor, causing an irradiation position of a spotlight to conform to the position of the subject, and matching an imaging range of a camera with the irradiation position.

### SUMMARY

However, in the related art, a dedicated lighting device needs to be used to imaging a subject.

The present disclosure provides a control device, a control method, and a streetlight that can facilitate imaging a subject in a dark place without using a dedicated lighting device.

According to an aspect of the disclosure, there is provided a control device including a control unit configured to acquire an image of a subject which is captured by a terminal device and to control at least one streetlight which is provided near the terminal device based on the acquired image.

According to another aspect of the disclosure, there is provided a control method which is performed by a control device, the control method including: acquiring an image of a subject which is captured by a terminal device; and controlling at least one streetlight which is provided near the terminal device based on the acquired image.

According to another aspect of the disclosure, there is provided a streetlight including: at least one light source unit; a communication unit configured to communicate with a control device; and a control unit configured to acquire an instruction from the control device via the communication unit and to change a quantity of light of the light source unit in accordance with the acquired instruction.

According to the aspects, it is possible to facilitate imaging a subject in a dark place without using a dedicated lighting device.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a configuration of a system according to an embodiment;

FIG. 2 is a block diagram illustrating a configuration of a control device, a terminal device, and a lighting device according to the embodiment;

FIG. 3 is a diagram illustrating an example of positions of a terminal device and a lighting device according to the embodiment;

FIG. 4A is a flowchart illustrating an operation flow which is performed by the system according to the embodiment;

FIG. 4B is a flowchart illustrating an operation flow which is performed by the system according to the embodiment; and

FIG. 5 is a diagram illustrating an example of an image which is acquired from a terminal device according to the embodiment.

### DETAILED DESCRIPTION OF EMBODIMENTS

Hereinafter, embodiments of the present disclosure will be described with reference to the accompanying drawings. In the drawings, the same or corresponding elements are referred to by the same reference signs. In this embodiment, description of the same or corresponding elements will be appropriately omitted or simplified.

### First Embodiment

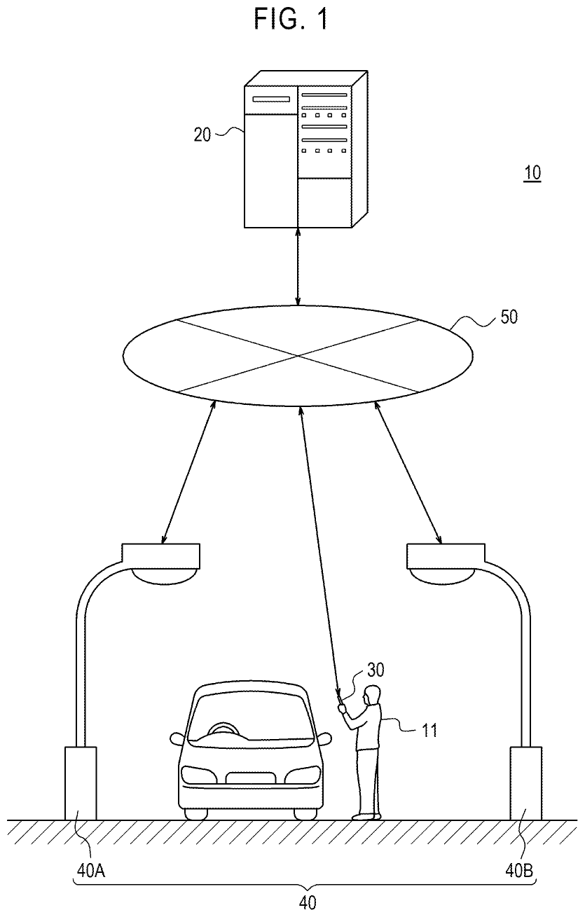

A configuration of a system 10 according to a first embodiment will be described below with reference to FIG. 1.

The system 10 according to this embodiment includes a control device 20, a terminal device 30, and one or more lighting devices 40. In FIG. 1, for the purpose of convenience of description, only two lighting devices 40 are illustrated, but the number of lighting devices 40 is not limited thereto and may be freely determined.

In the following description, when lighting devices 40A to 40F are not particularly distinguished, the lighting devices 40A to 40F are generically referred to as lighting devices 40.

The control device 20 can communicate with a terminal device 30 and the lighting devices 40 via a network 50.

The network 50 includes the Internet, at least one WAN, at least one MAN, or a combination thereof. “WAN” is an abbreviation for Wide Area Network. “MAN” is an abbreviation for Metropolitan Area Network. The network 50 may include at least one radio network, at least one optical network, or a combination thereof. The radio network is, for example, an ad hoc network, a cellular network, a wireless LAN, a satellite communication network, or a terrestrial microwave network. “LAN” is an abbreviation for Local Area Network.

The control device 20 is provided in a facility such as a data center. The control device 20 is, for example, a server which belongs to a cloud computing system or other computing system.

The terminal device 30 is used by a user 11. The terminal device 30 is, for example, a mobile device such as a mobile phone, a smartphone, a wearable device, or a tablet or a PC. “PC” is an abbreviation for Personal Computer.

The lighting device 40 is a device that can illuminate an outdoor or indoor fixed area. The lighting device 40 includes a streetlight which is provided on a road. The lighting device 40 may be provided in a building such as a public facility or a store, a signboard, a signal, a utility pole, and the like. The lighting device 40 can apply light to a road, a square, a parking lot, or the like in the vicinity of the lighting device 40. The lighting device 40 is, for example, a streetlight, but is not limited thereto. For example, an arbitrary lamp other than a lamp provided as a dedicated imaging lamp can be employed as the lighting device 40.

The summary of this embodiment will be described below with reference to FIG. 1.

In the system 10 illustrated in FIG. 1, the control device 20 includes a control unit 21 that acquires an image of a subject which is captured by the terminal device 30 and controls at least one lighting device 40 which is provided near the terminal device 30 based on the acquired image.

A “subject” includes a flaw which is formed on a vehicle. The vehicle includes, for example, a vehicle which is used in a car-sharing service. “Near the terminal device 30” includes a side in front, a side to the rear, sides to the side, and the like of the terminal device 30. More specifically, “near the terminal device 30” means near a place at which a user 11 of the terminal device 30 stands.

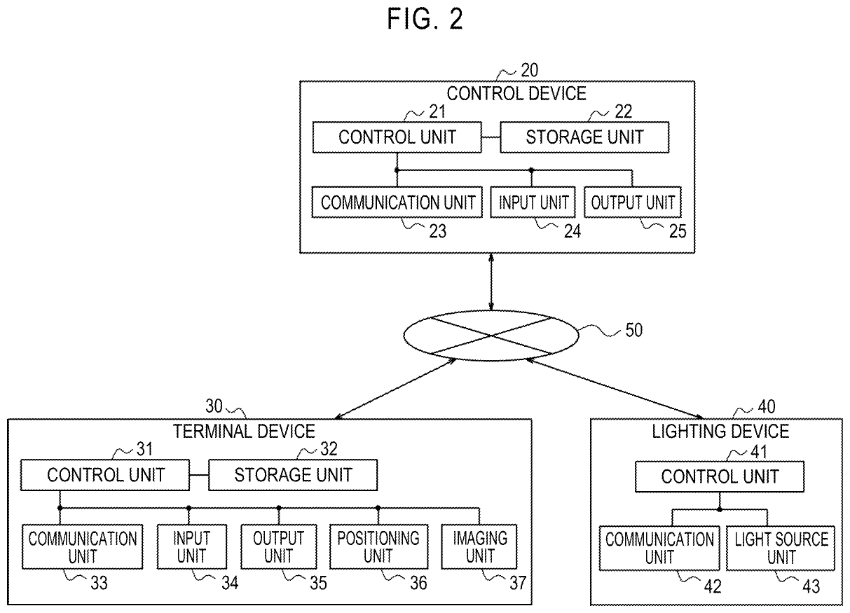

A configuration of the control device 20 according to this embodiment will be described below with reference to FIG. 2. The control device 20 includes a control unit 21, a storage unit 22, a communication unit 23, an input unit 24, and an output unit 25.

The control unit 21 includes at least one processor, at least one dedicated circuit, or a combination thereof. The processor may be a general-purpose processor such as a CPU or a GPU or a dedicated processor specialized in a specific process. “CPU” is an abbreviation for Central Processing Unit. “GPU” is an abbreviation for Graphics Processing Unit. The dedicate circuit may be, for example, an FPGA or an ASIC. “FPGA” is an abbreviation for Field-Programmable Gate Array. “ASIC” is an abbreviation for Application-Specific Integrated Circuit. The control unit 21 controls the constituents of the control device 20 and performs processes associated with operations of the control device 20.

The control unit 21 receives an image from the terminal device 30 via the communication unit 23. Accordingly, the control unit 21 acquires the image. The control unit 21 determines whether a brightness of the acquired image is less than a reference value. The brightness of the image specifically is an average value of luminance values of pixels included in the acquired image. The brightness of the image is not limited thereto and may be, for example, a level of a contrast ratio of the acquired image. The reference value is a value with which a subject to be imaged can be recognized and is, for example, a luminance value of 130. The reference value is not limited thereto and may be freely set. The control unit 21 can recognize a flaw on a vehicle as a subject. The control unit 21 may recognize a subject by analyzing the acquired image using a known image analysis technique. The control unit 21 may recognize a subject, for example, based on conditions which are generated by machine learning.

When it is determined that the brightness of the acquired image is less than the reference value, the control unit 21 requests the terminal device 30 to transmit position information indicating the position of the terminal device 30. The control unit 21 transmits the request to the terminal device 30 via the communication unit 23.

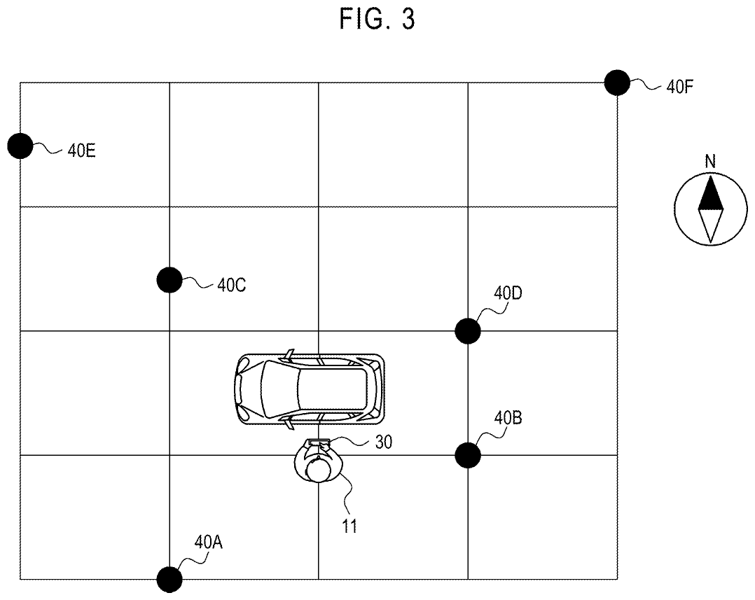

The control unit 21 receives the position information from the terminal device 30 via the communication unit 23. Accordingly, the control unit 21 acquires the position information. The control unit 21 refers to map information which is stored in the storage unit 22. Positions of the lighting devices 40 are registered in advance in the map information. The control unit 21 selects lighting devices 40 which are provided within a reference distance from the position of the terminal device 30 out of a plurality of lighting devices 40 registered in the map information. The reference distance is, for example, a distance of 10 m. The reference distance is not limited thereto and may be freely set. FIG. 3 is a diagram illustrating an example of the positions of the terminal device 30 and the lighting devices 40. In FIG. 3, the user 11 images a flaw on the vehicle which is a subject using the terminal device 30. In FIG. 3, positions of lighting devices 40A to 40F are indicated by black circles. Out of the lighting devices 40A to 40F, the lighting devices 40 provided within the reference distance from the position of the terminal device 30 are the lighting devices 40A to 40D. Accordingly, the control unit 21 first selects the lighting device 40A to 40D. In this way, the control unit 21 selects at least one lighting device 40 which is provided near the terminal device 30 out of the plurality of lighting devices 40.

The position information includes information on an orientation of the terminal device 30 in addition to information indicating the position of the terminal device 30. The control unit 21 further narrows down and selects the lighting devices 40 based on the orientation of the terminal device 30. The orientation of the terminal device 30 is specifically, an orientation of an imaging unit 37 of the terminal device 30. The control unit 21 selects the lighting devices 40 which are provided in the direction opposite to that of the orientation of the terminal device 30 with respect to the position of the terminal device 30 such that it does not serve as a backlight. Referring to FIG. 3, the orientation of the terminal device 30 is a northward direction. In this case, the control unit 21 selects the lighting devices 40A and 40B which are provided in the direction opposite to that of the orientation of the terminal device 30 out of the lighting devices 40A to 40D. The conditions of the lighting devices 40 which are selected based on the orientation of the terminal device 30 are not limited thereto and may be freely determined.

The control unit 21 requests the selected lighting device 40 to transmit lighting information indicating a result of detection of a lighting state of the light source unit 43. The control unit 21 transmits the request to the lighting device 40 via the communication unit 23. The control unit 21 receives lighting information transmitted from the lighting device 40 via the communication unit 23. In this way, the control unit 21 acquires the lighting information.

The control unit 21 determines an operation which is instructed to the selected lighting device 40 based on the acquired lighting information. When the lighting information indicates that the lighting device is turned off, the control unit 21 determines an operation of turning on the light source unit 43. When the lighting information indicates that the lighting device is turned on, the control unit 21 may determine an operation of turning on the light source unit 43 in a state in which the number of light emitting elements which are turned on is increased. The type of the operation which is determined by the control unit 21 is not limited thereto and may be freely set.

When the number of selected lighting devices 40 is two or more, the control unit 21 may determine different operations for the lighting devices 40. For example, the control unit 21 may determine operations of turning on the light source units 43 in a state in which different numbers of light emitting elements are turned on in the lighting device 40A and the lighting device 40B.

The control unit 21 transmits an instruction of the determined operation to the selected lighting device 40. The control unit 21 transmits the instruction of the operation via the communication unit 23. The lighting device 40 receives the instruction of the operation and operates in accordance with the instruction. In this way, the control unit 21 increases the quantity of light of the lighting device 40.

The control unit 21 transmits a notification for capturing an image again to the terminal device 30 after transmitting the instruction of the operation. The control unit 21 transmits the notification to the terminal device 30 via the communication unit 23. The terminal device 30 receiving the notification performs imaging of the subject again. When the notification is received via the communication unit 33, the control unit 31 of the terminal device 30 may control the imaging unit 37 such that it captures an image again. The control unit 31 of the terminal device 30 may display the received notification to the user 11 via the output unit 35. Accordingly, the user 11 can recognize display of the notification and operate the terminal device 30 to capture an image again.

Until it is determined that the brightness of the acquired image from the terminal device 30 is equal to or greater than the reference value, the control unit 21 repeatedly performs acquisition of an image from the terminal device 30 and control of the lighting devices 40. In this repetition, the control unit 21 can determine an operation which is instructed to the selected lighting device 40 to be different from a previously determined operation. For example, it can be assumed that a previously determined operation is an operation of turning on the light source unit 43 in a state in which a predetermined number of light emitting elements are turned on. In this case, in this repetition, the control unit 21 may determine the operation of turning on the light source unit 43 in a state in which a number of light emitting elements which is larger than the predetermined number or which is less than the predetermined number are turned on. Accordingly, the quantity of light of the lighting device 40 can be changed in various patterns.

Since the control device 20 controls the lighting devices 40 in this way, the terminal device 30 can capture an image under various types of brightnesses.

The storage unit 22 includes at least one semiconductor memory, at least one magnetic memory, at least one optical memory, or a combination of at least two types thereof. The semiconductor memory is, for example, a RAM or a ROM. “RAM” is an abbreviation for Random Access Memory. “ROM” is an abbreviation for Read Only Memory. The RAM is, for example, an SRAM or a DRAM. “SRAM” is an abbreviation for Static Random Access Memory. “DRAM” is an abbreviation for Dynamic Random Access Memory. The ROM is, for example, an EEPROM. “EEPROM” is an abbreviation for Electrically Erasable Programmable Read Only Memory. The storage unit 22 may serve as, for example, a main storage device, an auxiliary storage device, or a cache storage device. The storage unit 22 stores information which is used for the operation of the control device 20 and information which is acquired through the operation of the control device 20. The storage unit 22 stores a system program, an application program, and map information. The positions of the lighting devices 40 are registered in advance in the map information. The map information is not stored in advance in the storage unit 22, but may be stored in an external system such as a GIS over the Internet. “GIS” is an abbreviation for Geographic Information System.

The communication unit 23 includes at least one communication interface. The communication interface is, for example, a LAN interface. The communication unit 23 receives information which is used for the operation of the control device 20 and transmits information which is acquired through the operation of the control device 20.

The input unit 24 includes at least one input interface. The input interface may be, for example, a physical key, a capacitance key, a pointing device, a touch screen which is provided integrally with a display, or a microphone. The input unit 24 receives an operation of inputting information which is used for the operation of the control device 20. The input unit 24 is not provided in the control device 20, but may be an external input device which is connected to the control device 20. In the connection method, for example, an arbitrary method such as a USB, an HDMI (registered trademark), or Bluetooth (registered trademark) can be used. “USB” is an abbreviation for Universal Serial Bus. “HDMI (registered trademark)” is an abbreviation for High-Definition Multimedia Interface.

The output unit 25 includes at least one output interface. The output interface is, for example, a display or a speaker. The display is, for example, an LCD or an organic EL display. “LCD” is an abbreviation for Liquid Crystal Display. “EL” is an abbreviation for Electro Luminescence. The output unit 25 outputs information which is acquired through the operation of the control device 20. The output unit 25 is not provided in the control device 20, but may be an external output device which is connected to the control device 20. In the connection method, for example, an arbitrary method such as a USB, an HDMI (registered trademark), or Bluetooth (registered trademark) can be used.

The functions of the control device 20 are realized by causing a processor corresponding to the control unit 21 to execute a control program according to this embodiment. That is, the functions of the control device 20 are realized by software. The control program causes a computer to serve as the control device 20 by causing the computer to execute the operations of the control device 20. That is, the computer serves as the control device 20 by executing the operations of the control device 20 in accordance with the control program.

A program can be recorded on a non-transitory computer-readable recording medium. The non-transitory computer-readable recording medium is, for example, a magnetic recording device, an optical disc, a magneto-optical recording medium, or a semiconductor memory. The program is distributed, for example, by selling, transferring, or lending a portable recording medium such as a DVD or CD-ROM having the program recorded thereon. “DVD” is an abbreviation for Digital Versatile Disc. “CD-ROM” is an abbreviation for Compact-Disc Read Only Memory. Alternatively, a program may be distributed by storing the program in a storage of a server and transmitting the program from the server to another computer. The program may be provided as a program product.

For example, the computer temporarily stores the program recorded on the portable recording medium or the program transmitted from the server in a main storage device. Then, the computer causes the processor to read the program stored in the main storage device and causes the processor to perform processing based on the read program. The computer may directly read the program from the portable recording medium and perform processing based on the program. Whenever the program is transmitted from the server to the computer, the computer may sequentially perform processing based on the received program. The processing may be performed by a so-called ASP service in which transmission of the program from the server to the computer is not performed and the functions are realized simply by instruction of execution and acquisition of a result. “ASP” is an abbreviation for Application Service Provider. The program includes information which is provided for processing in a computer and which is based on the program. For example, data which is not a direct command to a computer but has characteristics for defining processing in the computer corresponds to the “information which is based on the program.”

Some or all of the functions of the control device 20 may be realized by a dedicated circuit corresponding to the control unit 21. That is, some or all of the functions of the control device 20 may be realized by hardware.

The configuration of the terminal device 30 according to this embodiment will be described below with reference to FIG. 2. The terminal device 30 includes a control unit 31, a storage unit 32, a communication unit 33, an input unit 34, an output unit 35, a positioning unit 36, and an imaging unit 37.

The control unit 31 includes at least one processor, at least one dedicated circuit, or a combination thereof. The processor may be, for example, a general-purpose processor such as a CPU or a GPU or a dedicated processor specialized in a specific process. The dedicated circuit may be, for example, an FPGA or an ASIC. The control unit 31 controls the constituents of the terminal device 30 and performs processing associated with the operations of the terminal device 30.

The storage unit 32 includes at least one semiconductor memory, at least one magnetic memory, at least one optical memory, or a combination of at least two types thereof. The semiconductor memory is, for example, a RAM or a ROM. The RAM is, for example, an SRAM or a DRAM. The ROM is, for example, an EEPROM. The storage unit 32 may serve as, for example, a main storage device, an auxiliary storage device, or a cache memory. The storage unit 32 stores information which is used for the operation of the terminal device 30 and information which is acquired through the operation of the terminal device 30.

The communication unit 33 includes at least one communication interface. The communication interface is, for example, a communication interface corresponding to a mobile communication standard such as an LTE standard, a 4G standard, or a 5G standard, a communication interface corresponding to short-range radio communication such as Bluetooth (registered trademark), or a LAN interface. “LTE” is an abbreviation for Long Term Evolution. “4G” is an abbreviation for 4th Generation. “5G” is an abbreviation for 5th Generation. The communication unit 33 receives information which is used for the operation of the terminal device 30 and transmits information which is acquired through the operation of the terminal device 30.

The input unit 34 includes at least one input interface. The input interface may be, for example, a physical key, a capacitance key, a pointing device, a touch screen which is provided integrally with a display, or a microphone. The input unit 34 receives an operation of inputting information which is used for the operation of the terminal device 30. The input unit 34 is not provided in the terminal device 30, but may be an external input device which is connected to the terminal device 30. In the connection method, for example, an arbitrary method such as a USB, an HDMI (registered trademark), or Bluetooth (registered trademark) can be used.

The output unit 35 includes at least one output interface. The output interface is, for example, a display, a speaker, or a vibration motor. The display is, for example, an LCD or an organic EL display. The output unit 35 outputs information which is acquired through the operation of the terminal device 30. The output unit 35 is not provided in the terminal device 30, but may be an external output device which is connected to the terminal device 30. In the connection method, for example, an arbitrary method such as a USB, an HDMI (registered trademark), or Bluetooth (registered trademark) can be used.

The positioning unit 36 includes at least one GNSS receiver. “GNSS” is an abbreviation for Global Navigation Satellite System. For example, the GNSS includes at least one of GPS, QZSS, BeiDou, GLONASS, or Galileo. “GPS” is an abbreviation for Global Positioning System. “QZSS” is an abbreviation for Quasi-Zenith Satellite System. A satellite of the QZSS is called as a quasi-zenith satellite. “GLONASS” is an abbreviation for Global Navigation Satellite System. The positioning unit 36 includes a geomagnetic sensor and an acceleration sensor. The positioning unit 36 can detect the position of the terminal device 30 and an orientation of the terminal device 30. Specifically, the orientation of the terminal device 30 is an orientation of the imaging unit 37. Information indicating the position of the terminal device 30 and the orientation of the terminal device 30 which are detected by the positioning unit 36 is acquired as position information by the control unit 31. The position information is transmitted to the control device 20 by the control unit 31. Transmission of the position information is performed in response to a request from the control device 20 in this embodiment, but is not limited thereto and transmission of the position information may be normally performed.

The imaging unit 37 is a camera that images the surroundings of the terminal device 30. The imaging unit 37 can acquire a still image or a moving image according to an operation of the user 11. The imaging unit 37 can output the acquired image to the control unit 31. The imaging unit 37 is provided, for example, on the surface opposite to the output unit 35.

The functions of the terminal device 30 are realized by causing a processor corresponding to the control unit 31 to execute a terminal program according to this embodiment. That is, the functions of the terminal device 30 are realized by software. The terminal program causes a computer to serve as the terminal device 30 by causing the computer to execute the operations of the terminal device 30. That is, the computer serves as the terminal device 30 by executing the operations of the terminal device 30 in accordance with the terminal program.

Some or all of the functions of the terminal device 30 may be realized by a dedicated circuit corresponding to the control unit 31. That is, some or all of the functions of the terminal device 30 may be realized by hardware.

The configuration of a lighting device 40 according to this embodiment will be described below with reference to FIGS. 1 and 2. As illustrated in FIG. 2, the lighting device 40 includes a control unit 41, a communication unit 42, and a light source unit 43.

The control unit 41 includes at least one processor, at least one dedicated circuit, or a combination thereof. The processor may be a general-purpose processor such as a CPU or a GPU or a dedicated processor specialized in a specific process. The dedicated circuit may be, for example, an FPGA or an ASIC. The control unit 41 controls the constituents of the lighting device 40 and performs processing associated with the operations of the lighting device 40.

The control unit 41 detects a lighting state of the light source unit 43 and acquires the result of detection as lighting information. The lighting information includes information on whether the light source unit 43 of the lighting device 40 is turned on. The lighting information may additionally include information indicating the number of light emitting elements which are turned on. The control unit 41 transmits the lighting information to the control device 20 via the communication unit 42. Transmission of the lighting information is performed in response to a request from the control device 20. Without being limited thereto, transmission of the lighting information may be normally performed.

The control unit 41 receives an instruction of an operation from the control device 20 via the communication unit 42. The control unit 41 controls the light source unit 43 in accordance with the received instruction. The control unit 41 can turn on or turn off the light source unit 43 in accordance with the received instruction. The control unit 41 can turn on the light source unit 43 in a state in which the number of light emitting elements which are turned on is increased in accordance with the received instruction.

The communication unit 42 includes at least one communication interface. The communication interface is, for example, a communication interface corresponding to a mobile communication standard such as an LTE standard, a 4G standard, or a 5G standard. The communication unit 42 receives information which is used for the operation of the lighting device 40 and transmits information which is acquired through the operation of the lighting device 40.

The light source unit 43 includes one or more light emitting elements in a housing. Each light emitting element includes an LED or an organic EL. “LED” is an abbreviation for Light Emitting Diode. The light source unit 43 is turned on or turned off under the control of the control unit 41. The number of light emitting elements which are turned on may be increased or decreased under the control of the control unit 41. A quantity of light of the lighting device 40 changes in this way. The light source unit 43 includes a lid that covers the light emitting elements and the quantity of light of the lighting device 40 may change by opening or closing the lid under the control of the control unit 41.

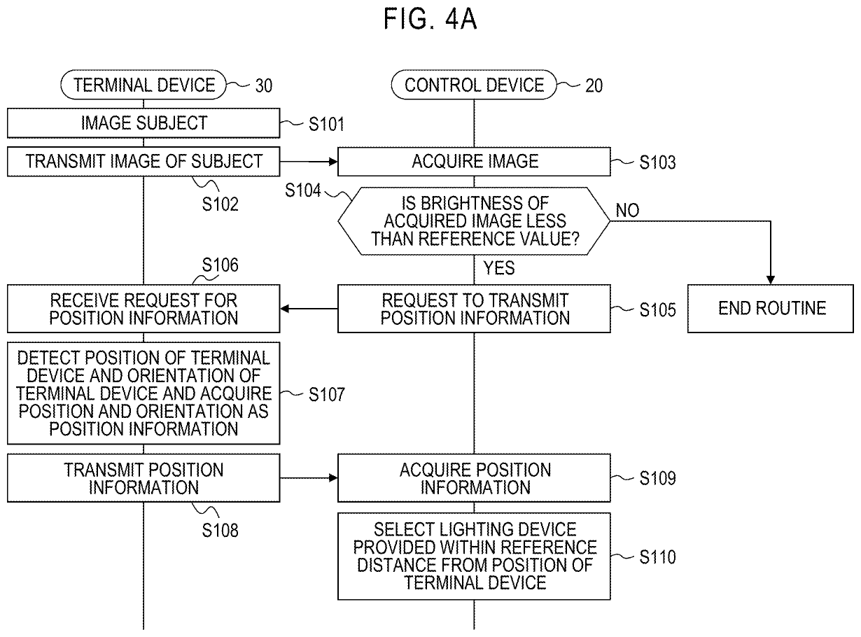

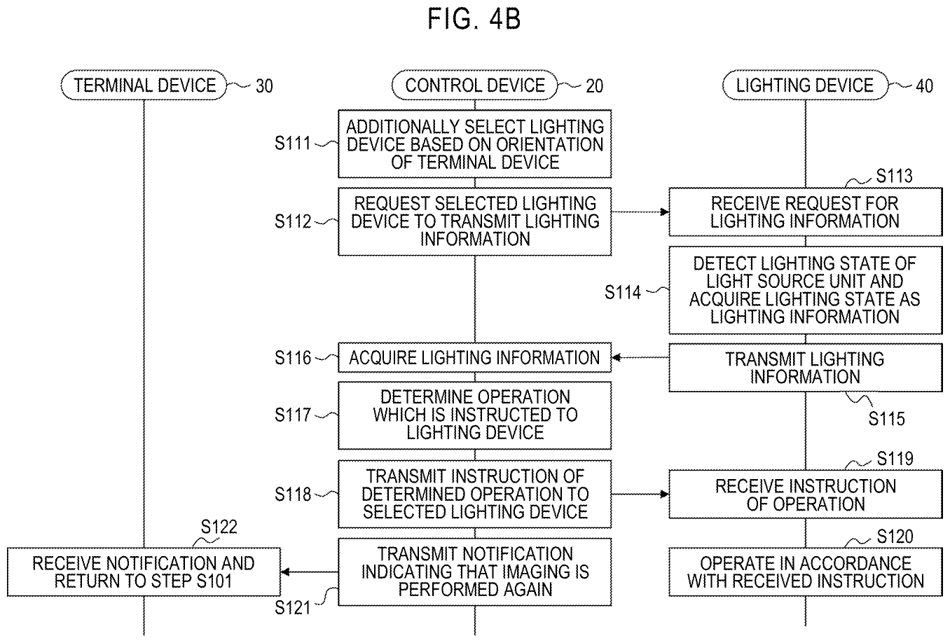

The operation of the system 10 according to this embodiment will be described below with reference to FIGS. 3, 4A, and 4B. This operation corresponds to a control method according to this embodiment. In this example, it is assumed that the user 11 images a flaw on a vehicle body of a vehicle using the terminal device 30. In this example, a lighting device 40A includes a control unit 41A, a communication unit 42A, and a light source unit 43A. In this example, a lighting device 40B includes a control unit 41B, a communication unit 42B, and a light source unit 43B. In this example, for the purpose of convenience, only one lighting device 40 is illustrated in FIG. 4B. FIGS. 4A and 4B illustrate a process flow of the whole system 10 according to this embodiment.

In Step S101 illustrated in FIG. 4A, the terminal device 30 images a subject. In this example, the imaging unit 37 of the terminal device 30 images a flaw formed on a vehicle as a subject. The control unit 31 of the terminal device 30 acquires an image captured by the imaging unit 37.

In Step S102, the terminal device 30 transmits the captured image of the subject to the control device 20. In this example, the control unit 31 of the terminal device 30 transmits the image acquired from the imaging unit 37 to the control device 20 via the communication unit 33.

In Step S103, the control device 20 receives the image from the terminal device 30. In this example, the control unit 21 of the control device 20 receives the image from the terminal device 30 via the communication unit 23. In this way, the control device 20 acquires the image.

In Step S104, the control unit 21 determines whether a brightness of the acquired image is less than a reference value. When the control unit 21 determines that the brightness of the acquired image is equal to or greater than the reference value, the operation of the system 10 ends. When the control unit 21 determines that the brightness of the acquired image is less than the reference value, the operation of the system 10 proceeds to Step S105. In this example, the control unit 21 determines whether an average value of luminance values of pixels in the acquired image is less than 130 which is the reference value. In this example, the average value of the luminance values of the pixels in the acquired image is 100. Accordingly, the process of the control unit 21 proceeds to Step S105.

In Step S105, the control unit 21 requests the terminal device 30 to transmit position information. In this example, the control unit 21 transmits a request for position information to the terminal device 30 via the communication unit 23.

In Step S106, the terminal device 30 receives the request for position information. In this example, the control unit 31 of the terminal device 30 receives the request via the communication unit 33.

In Step S107, the terminal device 30 acquires the position information. In this example, the positioning unit 36 of the terminal device 30 detects the position of the terminal device 30 and the orientation of the imaging unit 37 of the terminal device 30. In this example, the orientation of the terminal device 30 is the northward direction. The control unit 31 of the terminal device 30 acquires information indicating the position of the terminal device 30 and the orientation of the terminal device 30 which are detected by the positioning unit 36 as the position information.

In Step S108, the terminal device 30 transmits the acquired position information to the control device 20. In this example, the control unit 31 of the terminal device 30 transmits the position information acquired from the positioning unit 36 to the control device 20 via the communication unit 33.

In Step S109, the control device 20 receives the position information from the terminal device 30. In this example, the control unit 21 of the control device 20 receives the position information from the terminal device 30 via the communication unit 23. In this way, the control device 20 acquires the position information.

In Step S110, the control unit 21 selects a lighting device 40 which is provided within a reference distance from the position of the terminal device 30 based on the position information of the terminal device 30 acquired in Step S109. In this example, the control unit 21 first selects a lighting device 40 which is provided within 10 m which is the reference distance from the position of the terminal device 30 out of a plurality of lighting devices 40 registered in the map information with reference to the map information stored in the storage unit 22. Referring to FIG. 3, the lighting device 40 provided within the reference distance from the position of the terminal device 30 out of the lighting devices 40A to 40F indicated by black circles includes the lighting devices 40A to 40D. The control unit 21 selects the lighting devices 40A to 40D.

In Step S111, the control unit 21 further narrows and selects the lighting devices 40 based on the orientation of the terminal device 30 included in the position information. The conditions of the lighting devices 40 which are selected based on the orientation of the terminal device 30 may be freely determined. In this example, the control unit 21 selects the lighting device 40 which is provided in the direction opposite to that of the orientation of the terminal device 30 with respect to the position of the terminal device 30 such that it does not serve as a backlight. Referring to FIG. 3, the orientation of the terminal device 30 is the northward direction. The control unit 21 selects the lighting device 40A and the lighting device 40B which are provided in the direction opposite to that of the orientation.

In Step S112, the control unit 21 requests the selected lighting device 40 to transmit lighting information. In this example, the control unit 21 transmits the request to the lighting device 40A and the lighting device 40B via the communication unit 23.

In Step S113, the lighting device 40 receives the request for lighting information. In this example, the control unit 41A of the lighting device 40A receives the request via the communication unit 42A. The control unit 41B of the lighting device 40B receives the request via the communication unit 42B.

In Step S114, the lighting device 40 acquires lighting information. In this example, the control unit 41A of the lighting device 40A detects a lighting state of the light source unit 43A and the control unit 41B of the lighting device 40B detects a lighting state of the light source unit 43B. In this example, the detected lighting states indicate that both the light source unit 43A and the light source unit 43B are turned on in a state in which a predetermined number of light emitting elements are turned on. The control unit 41A and the control unit 41B acquire the results of detection as lighting information.

In Step S115, the lighting device 40 transmits the lighting information to the control device 20. In this example, the control unit 41A of the lighting device 40A transmits the lighting information to the control device 20 via the communication unit 42A. The control unit 41B of the lighting device 40B transmits the lighting information to the control device 20 via the communication unit 42B.

In Step S116, the control device 20 receives the lighting information from the lighting devices 40. In this example, the control unit 21 of the control device 20 receives the lighting information from the lighting device 40A and the lighting device 40B via the communication unit 23. In this way, the control device 20 acquires the lighting information.

In Step S117, the control unit 21 determines an operation which is instructed to the selected lighting device 40. When the acquired lighting information indicates that the corresponding light source unit is turned off, the control unit 21 determines an operation of turning on the light source unit 43 of the lighting device 40. When the lighting information indicates that the corresponding light source unit is turned on, the control unit 21 determines an operation of turning on the light source unit 43 in a state in which the number of light emitting elements which are turned on is increased. The types of the operation which is determined by the control unit 21 are not limited thereto and may be freely set. In this example, the control unit 21 determines the operation of turning on the light source unit 43 in a state in which the number of light emitting elements which are turned on is increased in the light source unit 43A of the lighting device 40A and the light source unit 43B of the lighting device 40B.

In Step S118, the control unit 21 transmits an instruction of the operation determined in Step S117 to the selected lighting devices 40. In this example, the control unit 21 transmits the instruction of the operation to the lighting device 40A and the lighting device 40B via the communication unit 23. In this way, the control unit 21 controls the lighting devices 40.

In Step S119, the lighting device 40 receives the instruction of the operation from the control device 20. In this example, the control unit 41A of the lighting device 40A receives the instruction of the operation via the communication unit 42A. The control unit 41B of the lighting device 40B receives the instruction of the operation via the communication unit 42B.

In Step S120, the lighting device 40 operates in response to the instruction received in Step S119. In this example, the control unit 41A of the lighting device 40A turns on the light source unit 43A in a state in which the number of light emitting elements which are turned on is increased. The control unit 41B of the lighting device 40B also turns on the light source unit 43B in a state in which the number of light emitting elements which are turned on is increased.

In Step S121, the control device 20 transmits a notification for capturing an image again to the terminal device 30. In this example, the control unit 21 of the control device 20 transmits the notification to the terminal device 30 via the communication unit 23.

In Step S122, the terminal device 30 receives the notification from the control device 20. The operation of the terminal device 30 returns to Step S101. That is, the operation of the system 10 as a whole returns to Step S101. In Step S101, the terminal device 30 images the subject again. In this example, the control unit 31 of the terminal device 30 receives the notification via the communication unit 33. The control unit 31 controls the imaging unit 37 of the terminal device 30 such that it images the subject again.

As described above, the processes of Steps S101 to S122 are repeated until the operation flow ends based on the determination of the control unit 21 in Step S104. In this repetition, the operation which is determined in Step S117 by the control unit 21 may be determined to be different from the previously determined operation. For example, it is assumed that the previously determined operation is the operation of turning on the light source unit 43A and the light source unit 43B in a state in which a predetermined number of light emitting elements are turned on. In this case, the control unit 21 may determine an operation of turning on the light source unit 43A in a state in which a larger number of light emitting elements than the predetermined number is turned on and turning on the light source unit 43B in a state in which a smaller number of light emitting elements than the predetermined number is turned on. Accordingly, the quantity of light of the lighting devices 40 can be changed in various patterns.

As described above, the control device 20 according to this embodiment includes the control unit 21 that acquires an image of a subject captured by the terminal device 30 and controls at least one lighting device 40 provided near the terminal device 30 based on the acquired image.

The control unit 21 controls the lighting device 40 based on the image acquired from the terminal device 30. The terminal device 30 can image the subject again under a brighter environment after the lighting device 40 provided near has been controlled. Accordingly, it is possible to facilitate imaging a subject in a dark place without using a dedicated lighting device.

As described above, when the brightness of the image is less than the reference value, the control unit 21 controls the lighting device 40 by changing the quantity of light of the lighting device 40.

The control unit 21 can accurately determine the brightness of the acquired image based on predetermined preset reference value. The control unit 21 determines an operation which is instructed to the lighting device 40 based on the result of determination. The control unit 21 can determine an operation of increasing or decreasing the quantity of light of the lighting device 40. When a plurality of lighting devices 40 is selected, the control unit 21 can determine an operation of increasing the quantity of light of a certain lighting device 40 and decreasing the quantity of light of another lighting device 40 and flexibly control the lighting devices 40. Accordingly, the terminal device 30 can image the subject again under a brighter environment after the lighting devices 40 have been controlled. Accordingly, it is possible to facilitate imaging a subject in a dark place without using a dedicated lighting device.

As described above, the control unit 21 changes the quantity of light of the lighting device 40 by increasing the quantity of light of the light source unit 43 of the lighting device 40.

The control unit 21 can determine the operation of increasing the quantity of light of the light source unit 43 of the lighting device 40. The lighting device 40 receives an instruction of the operation and increases the quantity of light of the light source unit 43 in accordance with the received instruction. Accordingly, the terminal device 30 can image the subject again under a brighter environment after the lighting device 40 has been controlled. Accordingly, it is possible to facilitate imaging a subject in a dark place without using a dedicated lighting device.

As described above, the control device 20 further includes the communication unit 23 that communicates with the terminal device 30. The control unit 21 acquires an image from the terminal device 30 via the communication unit 23.

The control unit 21 can also acquire an image from a terminal device 30 located at a distant position via the communication unit 23. The control unit 21 can control the lighting device 40 based on the brightness of the acquired image. Accordingly, it is possible to facilitate imaging a subject in a dark place without using a dedicated lighting device.

As described above, the control unit 21 acquires position information indicating the position of the terminal device 30 via the communication unit 23 and selects at least one lighting device 40 which is provided near the terminal device 30 out of a plurality of lighting devices 40 based on the position information.

The control unit 21 can select a lighting device 40 located closer to the position of the terminal device 30 out of the plurality of lighting devices 40. Accordingly, the terminal device 30 can image the subject again under a brighter environment. Accordingly, it is possible to facilitate imaging a subject in a dark place without using a dedicated lighting device.

As described above, in the control device 20, the position information includes information on the orientation of the terminal device 30.

The control unit 21 can select a lighting device 40 near the terminal device 30 based on the orientation of the terminal device 30. The control unit 21 can select a more appropriate lighting device 40 in consideration of the orientation of the terminal device 30. Accordingly, it is possible to facilitate imaging a subject in a dark place without using a dedicated lighting device.

As described above, the control unit 21 selects a lighting device 40 provided within the reference distance from the position of the terminal device 30 and controls the selected lighting device 40.

The control unit 21 selects a lighting device 40 based on a preset reference distance. The reference distance can be flexibly set such that the reference distance is relatively large in a region in which the number of lighting devices 40 is small and the reference distance is relatively small in a region in which the number of lighting devices 40 is large. It is possible to efficiently select the lighting device 40 by setting the reference distance in this way. Accordingly, it is possible to facilitate imaging a subject in a dark place without using a dedicated lighting device.

As described above, the control unit 21 determines whether the brightness of the image is less than the reference value. Until it is determined that the brightness of the image is equal to or greater than the reference value, the control unit 21 repeatedly performs acquisition of an image of a subject and control of the lighting devices 40 based on the image.

The control unit 21 can continuously change the quantity of light of the lighting devices 40 until the image acquired by the terminal device 30 reaches an appropriate brightness. Accordingly, the terminal device 30 can perform imaging again in various types of brightnesses. Accordingly, it is possible to facilitate imaging a subject in a dark place without using a dedicated lighting device.

As described above, the lighting device 40 includes at least one light source unit 43, the communication unit 42 that communicates with the control device 20, and the control unit 41 that acquires an instruction from the control device 20 via the communication unit 42 and changes the quantity of light of the light source unit 43 in accordance with the acquired instruction.

The lighting device 40 generally includes a lighting device serving as a streetlight. The lighting device 40 changes the quantity of light of the light source unit 43 in accordance with an instruction from the control device 20 received via the communication unit 42. Accordingly, it is possible to facilitate imaging a subject in a dark place without using a dedicated lighting device.

As described above, the control unit 41 detects the lighting state of the light source unit 43 and transmits lighting information indicating the result of detection to the control device 20 via the communication unit 42.

The control device 20 acquires the lighting information of the lighting device 40 by receiving the lighting information. The control device 20 can flexibly determine the operation of the lighting device 40 based on the acquired lighting information. Accordingly, it is possible to facilitate imaging a subject in a dark place without using a dedicated lighting device.

### Second Embodiment

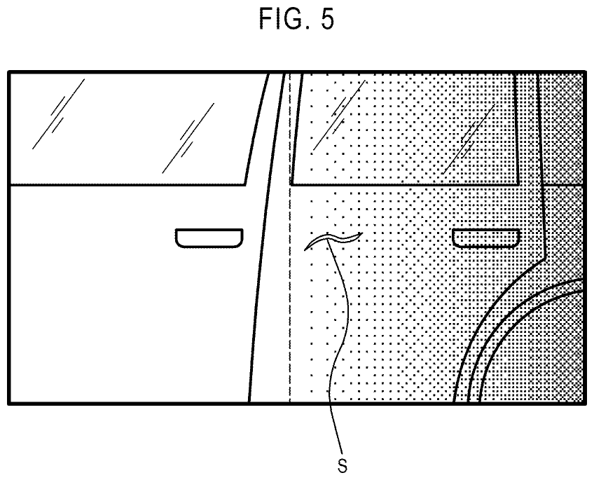

Differences between the first embodiment and a second embodiment will be described below with reference to FIGS. 3 and 5. FIG. 5 illustrates an example of an image acquired from a terminal device 30 according to this embodiment.

A system 10, a control device 20, a terminal device 30, and a lighting device 40 according to this embodiment have the same configurations as those in the first embodiment and thus description thereof will be omitted.

In this embodiment, the control unit 21 of the control device 20 divides an image acquired from the terminal device 30 into a plurality of areas. The control unit 21 can control the lighting device 40 based on the brightness of the divided areas.

For example, the control unit 21 divides the acquired image into right and left areas at the center. FIG. 5 illustrates an example of the divided images. In FIG. 5, a dotted line represents a line for dividing the image. Reference sign S represents a flaw on a vehicle which is a subject. The control unit 21 determines whether a brightness of each of the right and left areas of the divided images is less than a reference value. For example, the control unit 21 may determine that the brightness of the left area is equal to or greater than the reference value and the brightness of the right area is less than the reference value. The position of the division line, the number of divided areas, the shapes of the divided areas, and the like can be freely set.

In this embodiment, the control unit 21 selects the lighting devices 40 similarly to the first embodiment and then selects the lighting devices 40 based on the brightness of the divided images. Specifically, the control unit 21 further narrows down and selects the lighting devices 40 which are provided in the area in which the brightness is determined to be less than the reference value out of the selected lighting devices 40. For example, similarly to the first embodiment, it is assumed that the control unit 21 selects the lighting device 40A and the lighting device 40B. It is also assumed that the control unit 21 determines that the brightness of the right area of the image illustrated in FIG. 5 is less than the reference value. In this case, the control unit 21 selects the lighting device 40B which is provided in the right area of the divided images, that is, on the right side of the terminal device 30, out of the lighting device 40A and the lighting device 40B illustrated in FIG. 3.

Differences of the operation of the system 10 according to this embodiment from that in the first embodiment will be described below.

Steps S101 and S102 are the same as in the first embodiment and thus description thereof will be omitted.

In Step S103, the control device 20 acquires an image from the terminal device 30 and divides the acquired image into a plurality of areas. In this example, the control unit 21 of the control device 20 receives an image from the terminal device 30 via the communication unit 23. In this way, the control device 20 acquires the image. Then, the control unit 21 divides the acquired image into right and left areas at the center. The position of the division line, the number of divided areas, the shapes thereof, and the like can be freely set.

In Step S104, the control unit 21 determines whether the brightness of each of the sub-divided areas of the image divided in Step S103 is less than the reference value. When the control unit 21 determines that the brightness of each divided area of the image is equal to or greater than the reference value, the operation of the system 10 ends. When the control unit 21 determines that the brightness of a certain area is less than the reference value, the operation of the system 10 proceeds to Step S105. In this example, the control unit 21 determines whether an average value of luminance values of pixels in each area is less than 130 which is the reference value. In this example, the average value of the luminance values of the pixels in the right area is 100. Accordingly, the control unit 21 determines that the brightness of the right area is less than the reference value and the operation of the system 10 proceeds to Step S105.

Steps S105 to S110 are the same as those in the first embodiment and thus description thereof will be omitted.

In Step S111, similarly to the first embodiment, the control unit 21 selects the lighting devices 40 based on the orientation of the terminal device 30. In this example, similarly to the first embodiment, the control unit 21 selects the lighting device 40A and the lighting device 40B. In this embodiment, the control unit 21 further narrows down and selects the lighting devices 40 based on the brightness of the sub-divided areas. The conditions for the lighting devices 40 which are selected based on the brightness of the divided images can be freely determined. In this example, the control unit 21 further narrows down and selects the lighting devices 40 which are provided in the area in which the brightness is determined to be less than the reference value out of the selected lighting devices 40. In the image illustrated in FIG. 5, the control unit 21 determines that the brightness of the right area is less than the reference value. Accordingly, the control unit 21 selects the lighting device 40B which is provided in the right area, that is, on the right side of the terminal device 30, out of the lighting device 40A and the lighting device 40B illustrated in FIG. 3.

Steps S112 to S122 are the same as those in the first embodiment except that only the lighting device 40B is selected, and thus description thereof will be omitted.

As described above, the control unit 21 divides an image into a plurality of areas and controls the lighting devices 40 based on the brightness of the divided areas.

The control unit 21 can select and control the lighting device 40 which is provided in the area in which the brightness is determined to be less than the reference value out of a plurality of lighting devices 40 near the terminal device 30. That is, the control unit 21 can select the lighting device 40 which is provided particularly in a direction in which a brightness is necessary. Accordingly, it is possible to facilitate imaging a subject in a dark place without using a dedicated lighting device.

### Modified Example 1

In a modified example of this embodiment, the control unit 41 of a lighting device 40 can detect whether the light source unit 43 is available. When the quantity of light of the light source unit 43 cannot be changed for the purpose of safety, when a light emitting element has deteriorated, or the like, the control unit 41 can detect that the light source unit 43 is not available. The control unit 41 transmits information indicating the result of detection as availability information to the control device 20 via the communication unit 42. Transmission of availability information may be performed in response to a request from the control device 20 or may be normally performed. The control unit 21 of the control device 20 receives the availability information via the communication unit 23. In this way, the control device 20 acquires the availability information.

According to this modified example, it is possible to select only the lighting devices 40 which can be reliably controlled based on the availability information acquired by the control device 20. Accordingly, it is possible to facilitate imaging a subject in a dark place without using a dedicated lighting device. In addition, the control device 20 may transmit a notification indicating that a light emitting element has deteriorated to a terminal device which is used by a maintenance man who does maintenance of the lighting devices 40, or the like on the basis of the availability information. Accordingly, it is possible to easily find a lighting device 40 which needs maintenance and thus to continuously control the lighting device 40.

### Modified Example 2

In a modified example of this embodiment, the control unit 21 of the control device 20 selects a lighting device 40 based on the position information of the terminal device 30 instead of acquiring an image. The control unit 21 determines an operation which is instructed to the selected lighting device 40. For example, the control unit 21 determines an operation of turning on the light source unit 43 in a state in which all light emitting elements are turned on. The control unit 21 transmits an instruction of the determined operation to the selected lighting device 40. The lighting device 40 turns on the light source unit 43 in a state in which all the light emitting elements are turned on in accordance with the instruction of the operation from the control unit 21.

According to this modified example, the control unit 21 controls the lighting devices 40 which are provided near the terminal device 30 without determining the brightness of an image. Accordingly, it is possible to quickly control the lighting devices 40 near the terminal device 30 without applying a determination load on the control unit 21. Since the lighting devices 40 turn on the light source unit 43 in a state in which all the light emitting elements are turned on, the terminal device 30 can image a subject again with a maximum brightness.

### Modified Example 3

In a modified example of this embodiment, the control unit 21 of the control device 20 determines whether light from a lighting device 40 is reflected and glares in an acquired image. The control unit 21 determines whether a part or the whole of a subject is not imaged clearly because light from the lighting device 40 is reflected and glares. When it is determined that the subject is not imaged clearly, the control unit 21 identifies the lighting device 40 causing the glare of light. The control unit 21 determines an operation of decreasing the quantity of light of the identified lighting device 40. The control unit 21 may identify a lighting device 40 by analysis of an acquired image and estimation based on position information from the terminal device 30. The control unit 21 transmits an instruction of the determined operation to the identified lighting device 40 via the communication unit 23. The lighting device 40 decreases the quantity of light in accordance with the received instruction of the operation.

According to this modified example, the control unit 21 can control a lighting device 40 such that the quantity of light thereof decreases. Accordingly, when the terminal device 30 images a subject again, it is possible to acquire an image with an appropriate brightness. Accordingly, it is possible to facilitate imaging a subject in a dark place without using a dedicated lighting device.

The disclosure is not limited to the aforementioned embodiments and modified examples. For example, a plurality of blocks illustrated in the block diagram may be combined or one block may be divided. Instead of performing a plurality of steps illustrated in the flowchart in a time series as described above, the steps may be performed in parallel or in different order according to processing capability of a device that performs the steps or according to necessity. In addition, the disclosure can be modified without departing from the gist of the disclosure.

What is claimed is:

1. A control device comprising a control unit configured to:
acquire an image of a subject which is captured by a terminal device; and
control at least one streetlight which is provided near the terminal device based on the acquired image.

2. The control device according to claim 1, wherein the control unit is configured to control the streetlight by changing a quantity of light of the streetlight when a brightness of the image is less than a reference value.

3. The control device according to claim 2, wherein the control unit is configured to change the quantity of light of the streetlight by increasing a quantity of light of a light source unit of the streetlight.

4. The control device according to claim 2, further comprising a communication unit configured to communicate with the terminal device,
wherein the control unit is configured to acquire the image from the terminal device via the communication unit.

5. The control device according to claim 4, wherein the control unit is configured to acquire position information indicating a position of the terminal device via the communication unit and to select the at least one streetlight provided near the terminal device out of a plurality of the streetlights based on the position information.

6. The control device according to claim 5, wherein the position information includes information on an orientation of the terminal device.

7. The control device according to claim 5, wherein the control unit is configured to select a streetlight which is provided within a reference distance from the position of the terminal device and to control the selected streetlight.

8. The control device according to claim 2, wherein the control unit is configured to divide the image into a plurality of areas and to control the streetlight based on brightnesses of the sub-divided areas.

9. The control device according to claim 2, wherein the control unit is configured to:
determine whether the brightness of the image is less than the reference value; and
repeatedly perform acquisition of the image of the subject and control of the streetlight based on the image until it is determined that the brightness of the image is equal to or greater than the reference value.

10. A control method which is performed by a control device, the control method comprising:
acquiring an image of a subject which is captured by a terminal device; and
controlling at least one streetlight which is provided near the terminal device based on the acquired image.

11. The control method according to claim 10, further comprising controlling the streetlight by changing a quantity of light of the streetlight when a brightness of the image is less than a reference value.

12. The control method according to claim 11, further comprising changing the quantity of light of the streetlight by increasing a quantity of light of a light source unit of the streetlight.

13. The control method according to claim 11, wherein the control device includes a communication unit configured to communicate with the terminal device, and
wherein the control method further comprises acquiring the image from the terminal device via the communication unit.

14. The control method according to claim 13, further comprising:
acquiring position information indicating a position of the terminal device via the communication unit; and
selecting the at least one streetlight provided near the terminal device out of a plurality of the streetlights based on the position information.

15. The control method according to claim 14, wherein the position information includes information on an orientation of the terminal device.

16. The control method according to claim 14, further comprising:
selecting a streetlight which is provided within a reference distance from the position of the terminal device; and
controlling the selected streetlight.

17. The control method according to claim 11, further comprising:
dividing the image into a plurality of areas; and
controlling the streetlight based on brightnesses of the sub-divided areas.

18. The control method according to claim 11, further comprising:
determining whether the brightness of the image is less than the reference value; and
repeatedly performing acquisition of the image of the subject and control of the streetlight based on the image until it is determined that the brightness of the image is equal to or greater than the reference value.

19. A streetlight comprising:
at least one light source unit;
a communication unit configured to communicate with a control device; and
a control unit configured to acquire an instruction from the control device via the communication unit and to change a quantity of light of the light source unit in accordance with the acquired instruction.

20. The streetlight according to claim 19, wherein the control unit is configured to detect a lighting state of the light source unit and to transmit lighting information indicating a result of detection to the control device via the communication unit.
